(19) United States
(12) Patent Application Publication
(10) Pub. No.: US 2016/0050242 A1
(43) Pub. Date: Feb. 18, 2016

(54) METHODS AND DEVICES FOR PLAYING STREAMING MEDIA DATA

(71) Applicant: Xiaomi, Inc., Beijing (CN)

(72) Inventors: Feiyun Li, Beijing (CN); Ziguang Gao, Beijing (CN); Qiao Ren, Beijing (CN)

(21) Appl. No.: 14/748,242

(22) Filed: Jun. 24, 2015

Related U.S. Application Data
(63) Continuation of application No. PCT/CN2015/074615, filed on Mar. 19, 2015.

(30) Foreign Application Priority Data
Aug. 13, 2014 (CN) 201410405007.1

(51) Int. Cl. H04L 29/06; H04N 1/00; H04N 7/18

(52) U.S. Cl. CPC H04L 65/4069; H04N 7/18; H04N 1/00315; H04W 84/12

(57) ABSTRACT

The present disclosure provides methods and devices for playing streaming media data. The method includes: obtaining a playing address of a smart camera by a first terminal device; displaying a list of playback devices, in which the list includes device information of at least one terminal device, and the at least one terminal device has a function of playing the streaming media data; sending the playing address to a second terminal device if an instruction to select the second terminal device is received, such that the second terminal device obtains the streaming media data based on the playing address, and converts the streaming media data into an image for playing, the second terminal device being any terminal device of the at least one terminal device.

### CROSS-REFERENCE TO RELATED APPLICATIONS

This application is a Continuation application of International Application No. PCT/CN2015/074615, filed with the State Intellectual Property Office of P. R. China on Mar. 19, 2015, which is based on and claims priority to Chinese Patent Application No. 201410405007.1, filed on Aug. 13, 2014, the entire contents of which are incorporated herein by reference.

### TECHNICAL FIELD

The present disclosure relates to a field of home networking, and more particularly, to methods and devices for playing streaming media data.

### BACKGROUND

As wireless networks are becoming more common, smart cameras, which can be connected to a wireless network, are developing rapidly. When the smart camera is used for surveillance, the smart camera may acquire streaming media data, and play the acquired streaming media data through a playback device.

In the related art, a terminal device operates a camera APP corresponding to the smart camera to detect the smart camera which has been powered on. When receiving an instruction to configure the smart camera, the camera APP configures a name of the smart camera and a wireless local area network to be connected with. When the configuration is completed, the streaming media data acquired by the smart camera may be played on the terminal device via the camera APP.

In the above technologies, the streaming media data cannot be played on other devices except the terminal device provided with the camera client. In such a case, the playing of the streaming media data is limited by terminal devices, which results in poor flexibility of playing of the streaming media data.

### SUMMARY

In order to solve the problems existing in the related art, the present disclosure provides methods and devices for playing streaming media data.

According to a first aspect of embodiments of the present disclosure, there is provided a method for playing streaming media data. The method includes: obtaining a playing address of a smart camera by a first terminal device, the playing address represents an address for retrieving the streaming media data acquired by the smart camera; displaying a list of playback devices by the first terminal device, herein the list includes device information of at least one terminal device, and the at least one terminal device has a function of playing the streaming media data; sending the playing address to a second terminal device if the first terminal device receives an instruction to select the second terminal device, such that the second terminal device obtains the streaming media data based on the playing address, and converts the streaming media data into an image for playing, the second terminal device being any terminal device of the at least one terminal device.

According to a second aspect of embodiments of the present disclosure, there is provided a method for playing streaming media data. The method includes: receiving a playing address of a smart camera sent from a first terminal device by a second terminal device, the playing address corresponding to the streaming media data acquired by the smart camera; sending a request for obtaining the streaming media data to the smart camera by the second terminal device, the request carrying the playing address; and converting the streaming media data into an image for playing by the second terminal device when the second terminal device receives the streaming media data sent from the smart camera.

According to a third aspect of embodiments of the present disclosure, there is provided a device for playing streaming media data. The device includes: a processor; a memory configured to store instructions executable by the processor. The processor is configured to perform: obtaining a playing address of a smart camera, the playing address corresponding to the streaming media data acquired by the smart camera; displaying a list of playback devices, the list of playback devices including device information of at least one terminal device and the at least one terminal device having a function of playing the streaming media data; sending the playing address to a second terminal device when receiving an instruction to select the second terminal device; obtaining the streaming media data based on the playing address, and converting the streaming media data into an image for playing, the second terminal device being any terminal device of the at least one terminal device.

According to a fourth aspect of embodiments of the present disclosure, there is provided a device for playing streaming media data. The device includes: a processor; a memory configured to store instructions executable by the processor. The processor is configured to perform: receiving a playing address of a smart camera sent from a first terminal device, the playing address corresponding to the streaming media data acquired by the smart camera; sending a request for obtaining the streaming media data to the smart camera, the request carrying the playing address; and converting the streaming media data into an image for playing when receiving the streaming media data sent from the smart camera.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart of a method for playing streaming media data according to an exemplary embodiment.

FIG. 2 is a flow chart of another method for playing streaming media data according to an exemplary embodiment.

FIG. 3 is a flow chart of yet another method for playing streaming media data according to an exemplary embodiment.

FIG. 4 is a schematic diagram of a system for playing streaming media data according to an exemplary embodiment.

FIG. 5 is a schematic diagram of an interface of a camera APP in a first terminal device according to an exemplary embodiment.

FIG. 6 is a block diagram of an apparatus for playing streaming media data according to an exemplary embodiment.

FIG. 7 is a block diagram of another apparatus for playing streaming media data according to an exemplary embodiment.

FIG. 8 is a block diagram of a terminal device for playing streaming media data according to an exemplary embodiment.

FIG. 9 is a block diagram of another terminal device for playing streaming media data according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

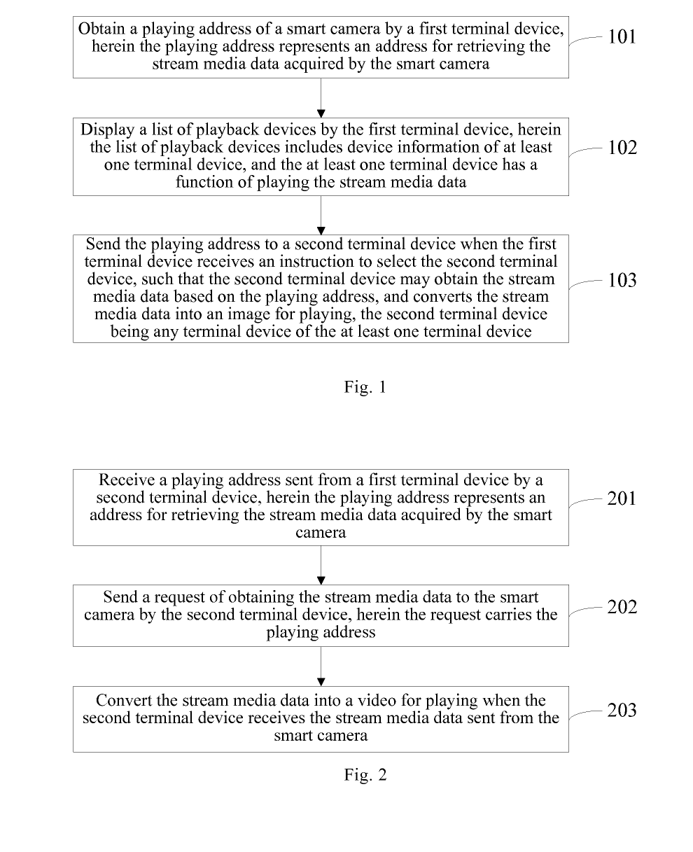

FIG. 1 is a flow chart of a method for playing streaming media data according to an exemplary embodiment. Referring to FIG. 1, the method may be applied in a first terminal device, and the first terminal device is a configuration terminal device and provided with a smart camera APP. The method includes the following steps.

In step 101, a first terminal device obtains a playing address of a smart camera, and the playing address represents an address for retrieving the streaming media data acquired by the smart camera.

In step 102, the first terminal device displays a list of playback devices, and the list of playback devices includes device information of at least one terminal device which has a function of playing the streaming media data.

In step 103, the first terminal device sends the playing address to a second terminal device if receiving an instruction to select the second terminal device, such that the second terminal device obtains the streaming media data based on the playing address, and converts the streaming media data into an image (such as an frame in a video) for playing, in which the second terminal device is any terminal device of the at least one terminal device.

In embodiments of the present disclosure, the first terminal device obtains the playing address of the smart camera, and then displays the list of playback devices, such that the user selects the second terminal device for playing the streaming media data based on the list of playback devices. After the second terminal device is determined, the first terminal device sends the playing address to the second terminal device, and the second terminal device obtains the streaming media data acquired by the smart camera and converts the data into images for playing. The list of playback devices may include other terminal devices besides the first terminal device. Thus, with the method according to embodiments of the present disclosure, the streaming media data can not only be played on the first terminal device equipped with the smart camera, but also freely switch to be played on other terminal devices, such that the streaming media data may be played without any limit to terminal devices, thus improving the flexibility of playing of the streaming media data.

Optionally, the step of obtaining the playing address of the smart camera by the first terminal device includes: obtaining address information of the smart camera by the first terminal device; and generating the playing address according to a specified format by the first terminal device based on the address information.

Optionally, the step of obtaining the address information of the smart camera by the first terminal device includes: receiving a broadcast data packet sent by the smart camera via a wireless local area network by the first terminal device, the broadcast data packet at least carrying the address information of the smart camera, and the wireless local area network being a network containing the smart camera and the first terminal device; or sending a request for obtaining the address information to a specified router by the first terminal device to obtain the address information of the smart camera from the specified router, if the smart camera is connected to the wireless local area network via the specified router; or scanning a graphic code on the smart camera by the first terminal device to obtain an identification of the smart camera, and sending the identification of the smart camera to a network server to obtain the address information of the smart camera from the network server.

Optionally, the step of displaying the list of playback devices by the first terminal device includes: sending a request for obtaining the list of playback devices to a specified router by the first terminal device when the at least one terminal device is connected to the wireless local area network via the specified router; receiving the list of playback devices sent from the specified router by the first terminal device; and displaying the list of playback devices by the first terminal device.

The above alternative technical solutions can form, in any combination, alternative embodiments of the present disclosure, which are not elaborated herein.

FIG. 2 is a flow chart of another method for playing streaming media data according to an exemplary embodiment. Referring to FIG. 2, the method may be applied in a second terminal device, and the second terminal device can be used to broadcast the streaming media data. The method includes the following steps.

In step 201, the second terminal device receives a playing address of a smart camera sent from a first terminal device, the playing address represents an address for retrieving the streaming media data acquired by the smart camera.

In step 202, the second terminal device sends a request for obtaining the streaming media data to the smart camera, herein the request carries the playing address.

In step 203, the second terminal device converts the streaming media data into an image for playing when receiving the streaming media data sent from the smart camera.

Optionally, before receiving the playing address sent from the first terminal device by the second terminal device, the method further includes: sending device information of the second terminal device to a specified router by the second terminal device if the second terminal device is connected to a wireless local area network via the specified router, such that the specified router may add the device information to the list of playback devices.

In embodiments of the present disclosure, the second terminal device obtains the playing address of the smart camera sent from the first terminal device, and then obtains the streaming media data from the smart camera according to the playing address, and converts the data into images for playing. The second terminal device can be a terminal device other than the first terminal device. Thus, with the method according to embodiments of the present disclosure, the streaming media data can not only be played on the first terminal device equipped with the smart camera, but also can freely switch to be play on other terminal devices, such that the streaming media data may be played without any limit to terminal devices, thus improving the flexibility of playing of the streaming media data.

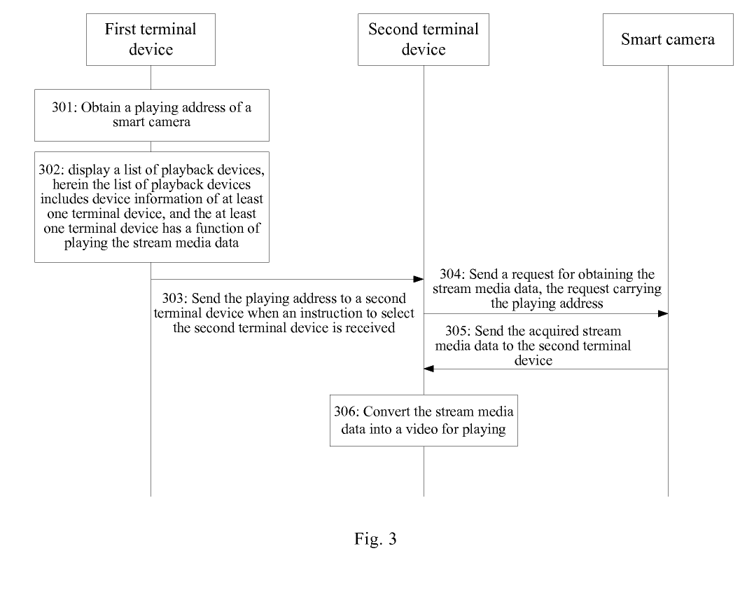

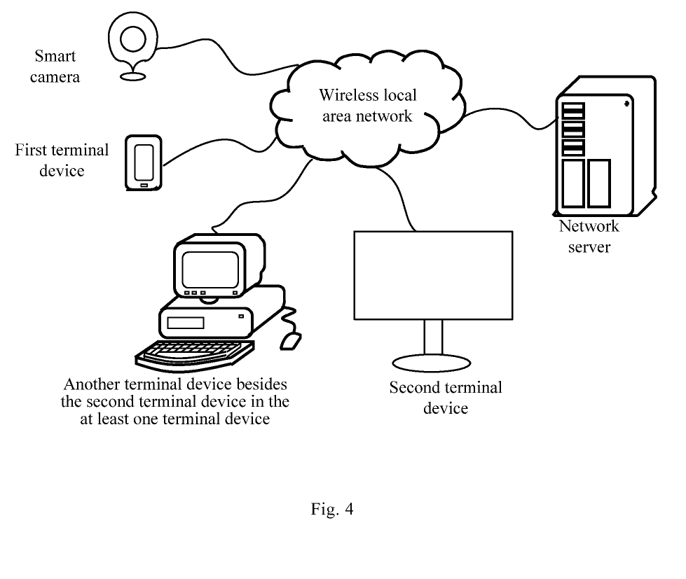

FIG. 3 is a flow chart of another method for playing streaming media data according to an exemplary embodiment. FIG. 4 is a schematic diagram of a system for playing streaming media data according to an exemplary embodiment. The system includes a smart camera, a first terminal device, a second terminal device, other terminal devices besides the second terminal device in the at least one terminal device, and a network server. The first terminal device is a terminal device equipped with the smart camera. Both the second terminal device and other terminal devices in the at least one terminal device are terminal devices having a function of playing streaming media data. The second terminal device is a target terminal device to which the streaming media data of the first terminal device is switched for playing. The network server is a server corresponding to the smart camera. Moreover, the smart camera, the first terminal device, the second terminal, other terminal devices besides the second terminal device in the at least one terminal device, and the network server are connected to the wireless local area network.

Referring to FIG. 3, the method for playing the streaming media data includes the following steps.

In step 301, a first terminal device obtains a playing address of a smart camera, and the playing address represents an address for retrieving the streaming media data acquired by the smart camera.

There may be a plurality of smart cameras in a wireless local area network. When the first terminal device configures the plurality of smart cameras via a camera APP, information of the plurality of smart cameras can be displayed in the list of cameras on the first terminal device. The smart camera referred to in the embodiments of the present disclosure is such a camera of the plurality of smart cameras that whose surveillance video needs to be viewed by a user. For example, there are three smart cameras in the wireless local area network, namely, smart camera 1, smart camera 2, and smart camera 3, and the user wants to view the monitor screen of smart camera 2. In such a case, smart camera 2 is the smart camera referred to in the embodiments of the present disclosure. The camera APP is installed in the first terminal device and the first terminal device can configure the smart camera via the camera APP.

The streaming media data may include audio data, video data and multi-media data. The playing address, such as a playing link, of the streaming media data is used to provide a guide to obtain the streaming media data. Thus, in order to obtain the streaming media data, the playing address of the streaming media data is needed to be obtained first. The operation of obtaining the playing address of the smart camera by the first terminal device may include: obtaining address information of the smart camera by the first terminal device; and generating the playing address according to a specified format by the first terminal device based on the address information.

Each device in the wireless local area network is assigned with address information. The address information is not only used to identify the device but also used to search for the device. The address information can be an Internet Protocol (IP) address. The address information of the smart camera may be obtained by the first terminal device in the following three ways.

In a first way, the first terminal device receives a broadcast data packet sent by the smart camera via a wireless local area network, in which the broadcast data packet at least carries the address information of the smart camera, and the wireless local area network is a network containing the smart camera and the first terminal device.

For the first way, when the smart camera in the wireless local area network is connected to the wireless local area network, the smart camera generates a broadcast data packet according to its own identification and address information. Then, the smart camera sends the broadcast data packet periodically via the wireless local area network, and the broadcast data packet carries the identification and address information of the smart camera. The first terminal device selects the broadcast data packet corresponding to the smart camera from the broadcast data packets received according to the identification of the smart camera, and then obtains the address information of the smart camera from the selected broadcast data packet.

It shall be noted that the broadcast data packet sent by the smart camera via the wireless local area network carries not only address information of the smart camera, but also other information, for example, a name of the smart camera, device information of the smart camera, etc., which will not be limited specifically in embodiments of the present disclosure.

In a second way, when the smart camera is connected to the wireless local area network via a specified router, the first terminal device sends a request of obtaining the address information to the specified router, so as to obtain the address information of the smart camera from the specified router.

In the wireless local area network, the smart camera can be connected to the wireless local area network not only by an ordinary router, but also can be connected by a specified router. For the second way, the specified router includes an interface between the specified router and the camera APP, so when the smart camera is connected to the wireless local area network via the specified router, the specified router may receive the request for obtaining the address information sent by the first terminal device via the interface between the specified router and the camera APP. The request may carry the identification of the smart camera. The specified router obtains corresponding address information from the stored corresponding relationship between identifications and address information of smart cameras according to the identification of the smart camera. The address information obtained is determined to be the address information of the smart camera. Then, the specified router sends the address information of the smart camera to the first terminal device via the interface between the specified router and the camera APP.

The identification of the smart camera may be the name of the smart camera, the number of the smart camera in the wireless local area network, the factory number of the smart camera, which is not limited specifically in embodiments of the present disclosure.

In a third way, the first terminal device scans a graphic code on the smart camera to obtain an identification of the smart camera, and sends the identification of the smart camera to a network server, so as to obtain the address information of the smart camera from the network server.

For the third way, the graphic code on the smart camera may be a QR code, a bar code, etc. The first terminal device scans the graphic code to obtain the identification of the smart camera, and sends the identification of the smart camera to the network server. If the network server receives the identification of the smart camera, the network server obtains corresponding address information from the stored corresponding relationship between identifications and address information of smart cameras according to the identification of the smart camera. The address information obtained is determined to be the address information of the smart camera. Then, the network server sends the address information of the smart camera to the first terminal device.

In embodiments of the present disclosure, the first terminal device can communicate not only with the smart camera and at least one terminal device in the wireless local area network, but also with a network server in the Internet. The network server in the Internet is a server corresponding to the smart camera and is used to store identification and address information of each smart camera. Of course, the network server can store other information and other processing functions, which are not limited specifically in embodiments of the present disclosure.

After obtaining the address information of the smart camera by any one of the above three ways, the first terminal device generates the playing address of the streaming media data acquired by the smart camera according to a specified format based on the address information. The specified format may be predetermined, for example, the specified format may be RTSP://address information/ch.264. Supposing that the address information of the smart camera obtained by the first terminal device is 120.22.144.110, by replacing the address information in the specified format RTSP://address information/ch.264 with 120.22.144.110, the first terminal device thus obtains that the playing address of the streaming media data acquired by the smart camera is RTSP:// 120.22.144.110/ch.264.

It shall be noted that in embodiments of the present disclosure, each camera has its own streaming media service in conformity with a streaming media transfer protocol, and thus each camera may convert the acquired data into the streaming medium data. The streaming media transfer protocol can be RTSP (Real Time Streaming Protocol) or other streaming protocols, which will is not limited specifically in embodiments of the present disclosure.

In step 302, the first terminal device displays a list of playback devices, and the list of playback devices includes device information of at least one terminal device which has a function of playing the streaming media data.

In order to switching the playing of streaming media data from the first terminal device to another terminal device, the first terminal device needs to display the list of playback devices.

Generally, the list of playback devices includes device information of at least one terminal device for playing the streaming media data, and the at least one terminal device needs to be connected to a wireless local area network to which the smart camera is connected. The operation of displaying the list of playback devices by the first terminal device may include: sending a request for obtaining the list of playback devices to a specified router by the first terminal device when the at least one terminal device is connected to the wireless local area network via the specified router. The first terminal device receives the list of playback devices sent by the specified router and displays the list of playback devices by the first terminal device.

After the specified router receives the request for obtaining the list sent by the first terminal device, the specified router sends the stored list to the first terminal device.

Further, when the at least one terminal device is connected to the wireless local area network via the specified router, the at least one terminal device sends device information of the at least one terminal device to the specified router, such that the specified router adds the received device information to the list of playback devices. Device information may contain the name and the address information of the playback device. For example, the device information of any one of the at least one terminal device include the name of the terminal device (Name 1) and the address information (Address 1). The specified router can add Name 1 and Address 1 to the list of the playback devices as shown in Table 1.

TABLE 1

| Name of Playback Device | Address Information |
|---|---|
| Name1 | Address1 |
| Name2 | Address2 |
| Name3 | Address3 |
| . . . | . . . |

In addition, when the first terminal device displays the list of the playback devices, the first terminal device can display all the information in the device formation, i.e. all contents in Table 1. Alternatively, the first terminal device may only display the names of the playback devices contained in the device information. The information to be displayed on the first terminal device is not limited specifically in embodiments of the present disclosure.

It shall be noted that, in embodiments of the present disclosure, the list of playback devices shown in Table 1 is only exemplary for illustration. In practical applications, the list of the playback devices can be displayed in various forms, which is not limited specifically in embodiments of the present disclosure.

Further, in embodiments of the present disclosure, when the first terminal device plays the streaming media data acquired by the smart camera, the first terminal device can directly display the list of playback devices on the interface on which the streaming media data are played. Of course, the first terminal device may not directly display the list of playback devices. Alternatively, the first terminal device may set a display button through which when a user triggers a display instruction, the first terminal device displays the list of playback devices based on the display instruction. That is, the first terminal device may either display the list of playback devices by or not by a triggering condition, which is not limited specifically in embodiments of the present disclosure.

It shall be noted that in embodiments of the present disclosure, the display instruction can be triggered not only by the display button but also by other conditions, for example, double clicking on the screen of the first terminal device. The triggering method of the display instruction is not limited specifically in embodiments of the present disclosure.

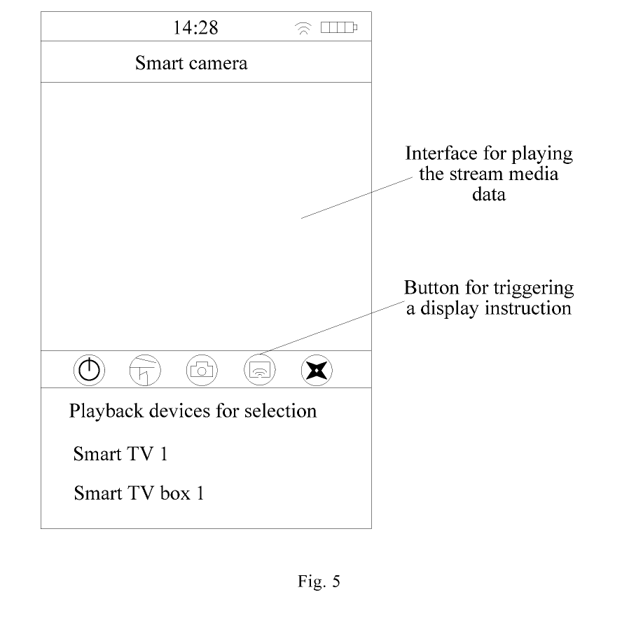

For example, referring to FIG. 5, triggering of a display instruction is illustrated by an example of a display button. When a display instruction is received by the display button, the list of playback devices for selection is shown in FIG. 5 is displayed, and the list of playback devices includes “Smart TV 1” and “Smart TV box 1”.

In step 303, when an instruction to select a second terminal device is received, the playing address of the streaming media data acquired by the smart camera is sent to the second terminal device, and the second terminal device is any one of the at least one terminal device.

When the first terminal device displays the list of playback devices, the user can select one terminal device from the list of playback devices as the second terminal device on which the streaming media data acquired by the smart camera are played. Further, the second terminal device may include an interface between the second terminal device and the camera APP. Thus, when the first terminal device receives the instruction to select a second terminal device, the first terminal device obtains device information of the second terminal device. Then, based on the device information of the second terminal device, the first terminal device sends the playing address of the smart camera to the second terminal device via the interface between the second terminal device and the camera APP.

The selection instruction may be triggered by the user and the triggering operation may be such as clicking, double clicking, sliding, voicing, etc.

In step 304, when the second terminal device receives the playing address sent by the first terminal device, the second terminal device sends a request for obtaining the streaming media data to the smart camera. The request carries the playing address.

After receiving the playing address sent by the first terminal device, the second terminal device determines that it is required to play the streaming media data acquired by the smart camera. Then, the second terminal device may send the request for obtaining the streaming media data to the smart camera to obtain the streaming media data from the smart camera.

In step 305, when the smart camera receives the request for obtaining the streaming media data, the smart camera sends the acquired streaming media data to the second terminal device.

After receiving the request of obtaining the streaming media data, the smart camera determines that the second terminal device is needed to play the streaming media data and sends the acquired streaming media data to the second terminal device.

In embodiments of the present disclosure, when the second terminal device is selected to play the streaming media data acquired by the smart camera, the first terminal device may also play the streaming media data acquired by the smart camera simultaneously. In such a case, the smart camera needs to send the acquired streaming media data to both the first terminal device and the second terminal device.

In step 306, when receiving the streaming media data acquired by the smart camera, the second terminal device converts the streaming media data into images for playing.

In embodiments of the present disclosure, the first terminal device may be a mobile device, such as a mobile phone, an IPAD, etc. The at least one terminal device can be a mobile device or a fixed device, such as a smart TV, an Internet TV box, etc.

In embodiments of the present disclosure, the first terminal device may obtain the playing address of the smart camera, and then display the list of playback devices for the user to select a second terminal device for playing the streaming media data from the list of playback devices. When the second terminal device is selected, the first terminal device sends the playing address to the second terminal device, such that the second terminal device obtains the streaming media data from the smart camera and converts the data into images for playing. The list of playback devices may include device information of other terminal devices other than the first terminal device. Thus, according to embodiments of the present disclosure, the streaming media data may not only be played on the first terminal device equipped with the smart camera, but also freely switch to be played on other terminal devices, such that the streaming media data may be played without any limit to terminals, thus improving the flexibility of playing of the streaming media data.

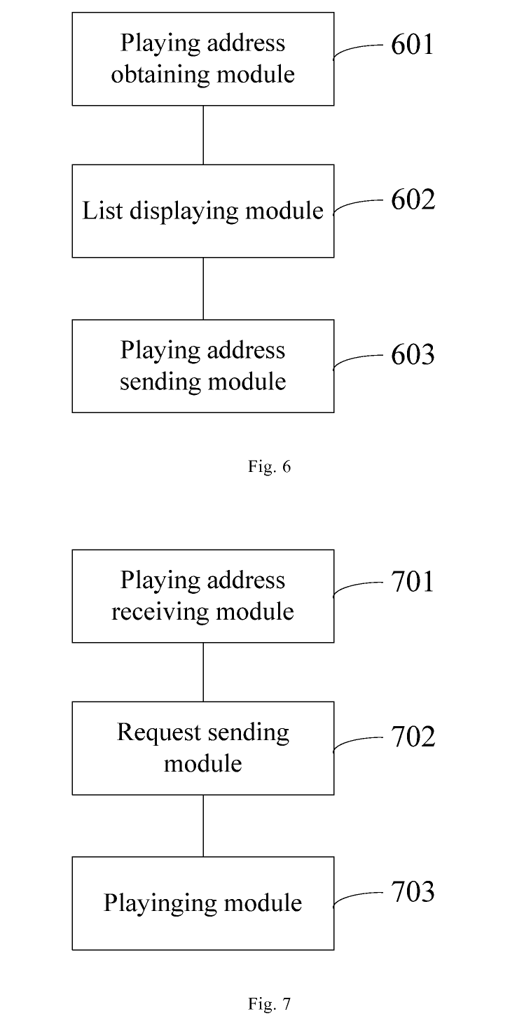

FIG. 6 is a block diagram of an apparatus for playing streaming media data according to an exemplary embodiment. Referring to FIG. 6, the apparatus includes a playing address obtaining module 601, a list displaying module 602, and a playing address sending module 603.

The playing address obtaining module 601 is configured to obtain a playing address of a smart camera, the playing address corresponding to the streaming media data acquired by the smart camera.

The list displaying module 602 is configured to display a list of playback devices, in which the list includes device information of at least one terminal device, and the at least one terminal device has a function of playing the streaming media data.

The playing address sending module 603 is configured to send the playing address to a second terminal device when receiving an instruction for selecting the second terminal device, such that the second terminal device obtains the streaming media data based on the playing address, and converts the streaming media data into an image for playing, the second terminal device being any terminal device of the at least one terminal device.

Optionally, the playing address obtaining module 601 includes: an address information obtaining unit configured to obtain address information of the smart camera; and a playing address generating unit configured to generate the playing address according to a specified format based on the address information.

Optionally, the address information obtaining unit includes: a receiving sub-unit configured to receive a broadcast data packet sent by the smart camera via a wireless local area network, in which the broadcast data packet at least carries the address information of the smart camera, and the wireless local area network is a network containing the smart camera and a first terminal device; or a sending sub-unit configured to send a request of obtaining the address information to a specified router to obtain the address information of the smart camera from the specified router, if the smart camera is connected to the wireless local area network via the specified router; or a scanning sub-unit configured to scan a graphic code on the smart camera to obtain an identification of the smart camera, and to send the identification of the smart camera to a network server to obtain the address information of the smart camera from the network server.

Optionally, the list displaying module 602 includes: a request sending unit configured to send a request for obtaining the list to a specified router when the at least one terminal device is connected to the wireless local area network via the specified router; a list receiving unit configured to receive the list of playback devices sent from the specified router; and a list displaying unit configured to display the list of playback devices.

In embodiments of the present disclosure, the playing address of the smart camera is obtained, and then the list of playback devices is displayed, such that the user selects a second terminal device for playing the streaming media data from the list. When the second terminal device is selected, the playing address is sent to the second terminal device, such that the second terminal device obtains the streaming media data acquired by the smart camera, and converts the data into images for playing. The list of playback devices may include device information of other terminal devices besides the first terminal device. Thus, according to the embodiments of the present disclosure, the streaming media data may not only be played on the first terminal device equipped with the smart camera, but also freely switch to be played on other terminal devices, such that the streaming media data may be played without any limit to terminals, thus improving the flexibility of playing of the streaming media data.

With respect to the devices in the above embodiments, the specific operation modes of individual modules therein have been described in detail in the embodiments regarding the methods, which will not be elaborated in detail herein.

FIG. 7 is a block diagram of another apparatus for playing streaming media data according to an exemplary embodiment. Referring to FIG. 7, the apparatus includes a playing address receiving module 701, a request sending module 702, and a playing module 703.

The playing address receiving module 701 is configured to receive a playing address sent from a first terminal device, in which the playing address represents an address for retrieving the streaming media data acquired by the smart camera.

The request sending module 702 is configured to send a request of obtaining streaming media data to the smart camera. The request carries the playing address.

The playing module 703 is configured to convert the streaming media data into an image for playing when receiving the streaming media data sent from the smart camera.

Optionally, the device further includes a device information sending module configured to send device information of a second terminal device to a specified router when the second terminal device is connected to a wireless local area network via the specified router, such that the specified router may add the device information to the list of playback devices.

In embodiments of the present disclosure, the playing address of the smart camera sent from the first terminal device is received. Then the streaming media data are obtained from the smart camera according to the playing address and converted into images for playing. The list of playback devices may include device information of other terminal devices other than the first terminal device. Thus, according to embodiments of the present disclosure, the streaming media data may not only be played by the first terminal device equipped with the smart camera, but also freely switch to be played on other terminal devices, such that the streaming media data may be played without any limit to terminals, thus improving the flexibility of playing of the streaming media data.

With respect to the devices in the above embodiments, the specific operation modes of individual modules therein have been described in detail in the embodiments regarding the methods, which will not be elaborated in detail herein.

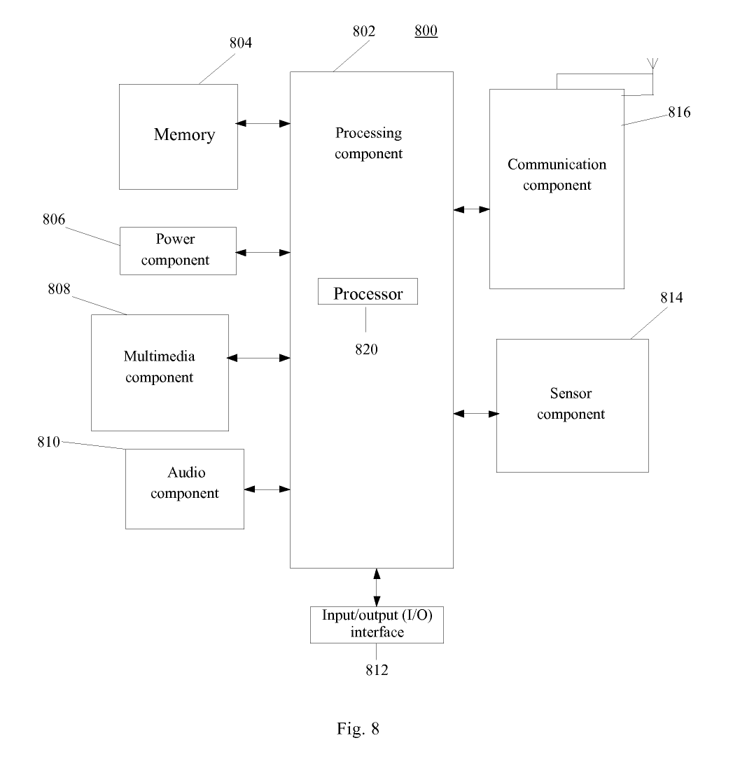

FIG. 8 is a block diagram of a terminal device 800 for playing streaming media data according to an exemplary embodiment. For example, the terminal device 800 may be a mobile phone, a computer, a digital broadcast terminal, a messaging device, a gaming console, a tablet, a medical device, exercise equipment, a personal digital assistant, and the like.

Referring to FIG. 8, the terminal device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal device 800. Examples of such data include instructions for any applications or methods operated on the terminal device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal device 800. The power component 806 may include a power management system, one or more power sources, and any other components associated with the generation, management, and distribution of power in the terminal device 800.

The multimedia component 808 includes a screen providing an output interface between the terminal device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the terminal device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the terminal device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal device 800. For instance, the sensor component 814 may detect an open/closed status of the terminal device 800, relative positioning of components, e.g., the display and the keypad, of the terminal device 800, a change in position of the terminal device 800 or a component of the terminal device 800, a presence or absence of user contact with the terminal device 800, an orientation or an acceleration/deceleration of the terminal device 800, and a change in temperature of the terminal device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal device 800 and other devices. The terminal device 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as the memory 804 including instructions. The above instructions are executable by the processor 820 in the terminal device 800, for performing the above-described methods. For example, the non-transitory computer-readable storage medium may be a ROM, a RAM, a CD-ROM, a magnetic tape, a floppy disc, an optical data storage device, and the like.

When the instructions included in the storage medium is executed by a processor of a first terminal device, the first terminal device performs a method for playing streaming media data. The method includes: obtaining a playing address of a smart camera, the playing address represents an address for retrieving the streaming media data acquired by the smart camera; displaying a list of playback devices, in which the list of playback devices includes device information of at least one terminal device, and the at least one terminal device has a function of playing the streaming media data; sending the playing address to a second terminal device when receiving an instruction to select the second terminal device, such that the second terminal device obtains the streaming media data based on the playing address, and converts the streaming media data into images for playing, the second terminal device being any terminal device of the at least one terminal device.

Optionally, obtaining the playing address of the smart camera includes: obtaining address information of the smart camera; and generating the playing address according to a specified format based on the address information.

Optionally, obtaining the address information of the smart camera includes: receiving a broadcast data packet sent by the smart camera via a wireless local area network, in which the broadcast data packet at least carries the address information of the smart camera, and the wireless local area network is a network containing the smart camera and the first terminal device; or sending a request for obtaining the address information to a specified router to obtain the address information of the smart camera from the specified router, if the smart camera is connected to the wireless local area network via the specified router; or scanning a graphic code on the smart camera to obtain an identification of the smart camera, and sending the identification of the smart camera to a network server to obtain the address information of the smart camera from the network server.

Optionally, displaying the list of playback devices includes: sending a request of obtaining the list of playback devices to a specified router when the at least one terminal device is connected to the wireless local area network via the specified router; receiving the list of playback devices sent from the specified router; and displaying the list of playback devices.

In embodiments of the present disclosure, the playing address of the smart camera is obtained, and then the list of playback devices is displayed, such that the user may select a second terminal device for playing the streaming media data from the list of playback devices. When the second terminal device is determined, the playing address is sent to the second terminal device, such that the second terminal device obtains the streaming media data acquired from the smart camera, and converts the data into images for playing. The list of playback devices can include device information of other terminal devices besides the first terminal device. Thus, according to the embodiments of the present disclosure, the streaming media data can not only be played on the first terminal device equipped with the smart camera, but also freely switch to be played on other terminal devices, such that the streaming media data may be played without any limit to terminals, thus improving the flexibility of playing the streaming media data.

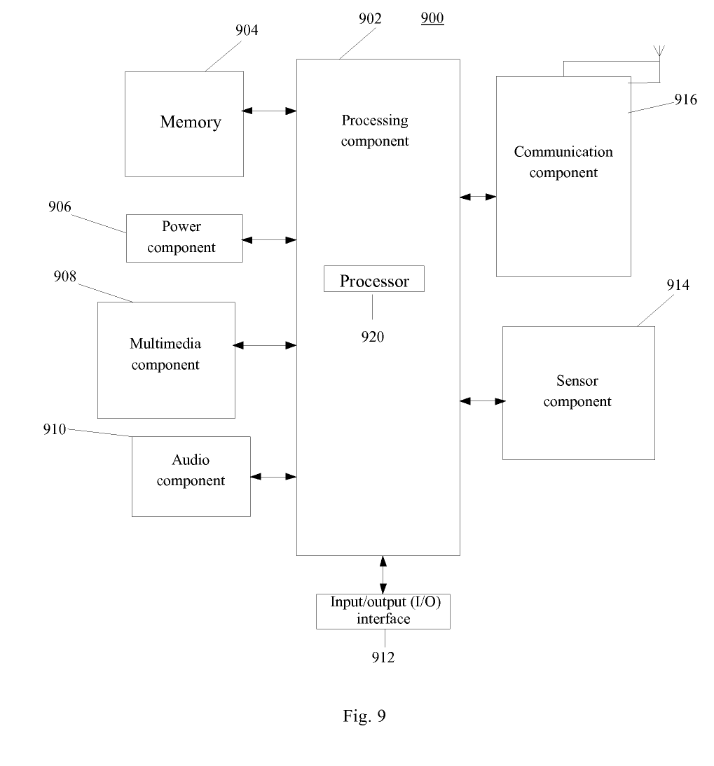

FIG. 9 is a block diagram of another terminal device 900 for playing streaming media data according to an exemplary embodiment. For example, the terminal device 900 may be a mobile phone, a computer, a digital broadcast terminal, a messaging device, a gaming console, a tablet, a medical device, exercise equipment, a personal digital assistant, and the like.

Referring to FIG. 9, the terminal device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the terminal device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the terminal device 900. Examples of such data include instructions for any applications or methods operated on the terminal device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the terminal device 900. The power component 906 may include a power management system, one or more power sources, and any other components associated with the generation, management, and distribution of power in the terminal device 900.

The multimedia component 908 includes a screen providing an output interface between the terminal device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia datum while the terminal device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (MIC) configured to receive an external audio signal when the terminal device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the terminal device 900. For instance, the sensor component 914 may detect an open/closed status of the terminal device 900, relative positioning of components, e.g., the display and the keypad, of the terminal device 900, a change in position of the terminal device 900 or a component of the terminal device 900, a presence or absence of user contact with the terminal device 900, an orientation or an acceleration/deceleration of the terminal device 900, and a change in temperature of the terminal device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the terminal device 900 and other devices. The terminal device 900 can access a wireless network based on a communication standard, such as WiFi, 2G, or 3G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as the memory 904 including instructions. The above instructions are executable by the processor 920 in the terminal device 900, for performing the above-described methods. For example, the non-transitory computer-readable storage medium may be a ROM, a RAM, a CD-ROM, a magnetic tape, a floppy disc, an optical data storage device, and the like.

When the instructions included in the storage medium is executed by a processor of a second terminal device, the second terminal device performs a method for playing streaming media data. The method includes: receiving a playing address sent from a first terminal device, in which the playing address represents an address for retrieving the streaming media data acquired by the smart camera; sending a request of obtaining the streaming media data to the smart camera, the request carrying the playing address; and converting the streaming media data into an image for playing when receiving the streaming media data sent from the smart camera.

Optionally, before receiving the playing address sent from the first terminal device, the method further includes: sending device information of the second terminal device to a specified router when the second terminal device is connected to a wireless local area network via the specified router, such that the specified router may add the device information to the list of playback devices.

In embodiments of the present disclosure, the playing address of the smart camera sent from the first terminal device is received, and then the streaming media data are obtained from the smart camera according to the playing address and converted into images for playing. The list of playback device may include device information of other terminal devices other than the first terminal device. Thus, according to embodiments of the present disclosure, the streaming media data may non only be played on the first terminal device equipped with the smart camera, but also freely switch to be played on other terminal devices, such that the streaming media data may be played without any limit to terminals, thus improving the flexibility of playing of the streaming media data.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for playing streaming media data, comprising:
obtaining a playing address of a smart camera by a first terminal device, wherein the playing address represents an address for retrieving the streaming media data acquired by the smart camera;
displaying a list of playback devices by the first terminal device, in which the list includes device information of at least one terminal device, and the at least one terminal device has a function of playing the streaming media data;
sending the playing address to a second terminal device if the first terminal device receives an instruction to select the second terminal device; and
obtaining the streaming media data based on the playing address and converts the streaming media data into an image for playing by the second terminal device, wherein the second terminal device is any terminal device of the at least one terminal device.

2. The method according to claim 1, wherein obtaining the playing address of the smart camera by the first terminal device, comprises:
obtaining address information of the smart camera by the first terminal device; and
generating the playing address according to a specified format by the first terminal device based on the address information.

3. The method according to claim 2, wherein obtaining address information of the smart camera by the first terminal device, comprises:
receiving by the first terminal device a broadcast data packet sent by the smart camera via a wireless local area network, wherein the broadcast data packet at least carries the address information of the smart camera, and the wireless local area network is a network containing the smart camera and the first terminal device.

4. The method according to claim 2, wherein obtaining address information of the smart camera by the first terminal device, comprises:
sending a request for obtaining the address information to a specified router by the first terminal device to obtain the address information of the smart camera from the specified router, wherein the smart camera is connected to the wireless local area network via the specified router.

5. The method according to claim 2, wherein obtaining address information of the smart camera by the first terminal device, comprises:
scanning a graphic code on the smart camera by the first terminal device to obtain an identification of the smart camera; and
sending the identification of the smart camera to a network server to obtain the address information of the smart camera from the network server.

6. The method according to claim 1, wherein displaying the list of the playback devices by the first terminal device, comprises:
sending a request for obtaining the list of the playback devices to a specified router by the first terminal device, wherein the at least one terminal device is connected to the wireless local area network via the specified router;
receiving the list of the playback devices sent from the specified router by the first terminal device; and
displaying the list of the playback devices by the first terminal device.

7. A method for playing streaming media data, comprising:
receiving a playing address of a smart camera sent from a first terminal device by a second terminal device, wherein the playing address corresponds to the streaming media data acquired by the smart camera;
sending a request for obtaining the streaming media data to the smart camera by the second terminal device, wherein the request carries the playing address; and
converting the streaming media data into an image for playing by the second terminal device when the second terminal device receives the streaming media data sent from the smart camera.

8. The method according to claim 7, wherein before receiving the playing address sent from the first terminal device by the second terminal device, the method further comprises:
sending device information of the second terminal device to a specified router by the second terminal device, wherein the second terminal device is connected to a wireless local area network via the specified router.

9. A terminal device for playing streaming media data, comprising:
a processor;
a memory configured to store instructions executable by the processor;
wherein the processor is configured to perform:
obtaining a playing address of a smart camera, wherein the playing address corresponds to the streaming media data acquired by the smart camera;
displaying a list of playback devices, wherein the list of playback devices includes device information of at least one terminal device, and the at least one terminal device has a function of playing the streaming media data;
sending the playing address to a second terminal device when receiving an instruction to select the second terminal device, wherein the second terminal device is any terminal device of the at least one terminal device; and
obtaining the streaming media data based on the playing address and converting the streaming media data into an image for playing by the second terminal device.

10. The terminal device according to claim 9, wherein obtaining the playing address of the smart camera comprises:
obtaining address information of the smart camera; and
generating the playing address according to a specified format based on the address information.

11. The terminal device according to claim 10, wherein obtaining address information of the smart camera comprises:
receiving a broadcast data packet sent by the smart camera via a wireless local area network, wherein the broadcast data packet at least carries the address information of the smart camera, and the wireless local area network is a network containing the smart camera and the terminal device.

12. The terminal device according to claim 10, wherein obtaining address information of the smart camera comprises:
sending a request for obtaining the address information to a specified router to obtain the address information of the smart camera from the specified router, wherein the smart camera is connected to the wireless local area network via the specified router.

13. The terminal device according to claim 10, wherein obtaining address information of the smart camera comprises:
scanning a graphic code on the smart camera to obtain an identification of the smart camera; and
sending the identification of the smart camera to a network server to obtain the address information of the smart camera from the network server.

14. The terminal device according to claim 9, wherein displaying the list of the playback devices comprises:
sending a request for obtaining the list of the playback devices to a specified router, wherein the at least one terminal device is connected to the wireless local area network via the specified router;
receiving the list of the playback devices sent from the specified router; and
displaying the list of the playback devices.

15. A terminal device for playing streaming media data, comprising:
a processor;
a memory configured to store instructions executable by the processor;
wherein the processor is configured to perform:
receiving a playing address of a smart camera sent from a first terminal device, wherein the playing address corresponds to the streaming media data acquired by the smart camera;
sending a request for obtaining the streaming media data to the smart camera, wherein the request carries the playing address; and
converting the streaming media data into an image for playing when receiving the streaming media data sent from the smart camera.

16. The terminal device according to claim 15, wherein before receiving the playing address sent from the first terminal device, the processor is configured to further perform:
sending device information of the terminal device to a specified router, wherein the terminal device is connected to a wireless local area network via the specified router.
